(19) United States
(12) Patent Application Publication
(10) Pub. No.: US 2003/0208373 A1
(43) Pub. Date: Nov. 6, 2003

(54) Networked digital displayed thinking system and display writing tool

(76) Inventors: William L. Collins JR., Cincinnati, OH (US); Scott D. Wampler, West Chester, OH (US); Jeffrey J. Vaitekunas, West Chester, OH (US)

Correspondence Address: JEFFREY J. VAITEKUNAS, 6081 INDIAN TRAIL, WEST CHESTER, OH, 45069, US

(21) Appl. No.: 10/422,110

(22) Filed: Apr. 24, 2003

Related U.S. Application Data
(60) Provisional application No. 60/377,094, filed on May 2, 2002.

(51) Int. Cl. G06F 17/60

(52) U.S. Cl. 705/1

(57) ABSTRACT

The present invention relates, in general, to a networked digital displayed thinking systems and display writing tools and, more particularly, to displayed thinking systems capable of writing, reading, storing, recalling, updating, and tele-conferencing displayed thinking concepts using a digital network format. A displayed thinking system according to the present invention could be made from a digital paper technology so that it could digitally display information and could be flexible enough to roll up into a container such as a movie screen does today. This system may also include a networked server that may be attached to the digital display board and may control what information would be displayed on it. This server would be able to receive information from the users and convert them into digital cards that could be displayed on the screen. The system may also include a set of user interfaces that may be networked into the server also. These user interfaces could be handheld computers or PDAs that may be held by the individual users and used to input information to the network server to be displayed. In an embodiment of. the present invention a stylus is provides, capable of writing directly onto the digital media. The digital media controller may be capable of reading the media to detect and record changes and additions to the display media produced from the stylus.

This application is related to, and claims the benefit of, U.S. provisional application serial No. 60/377,094 filed May 2, 2002.

### FIELD OF THE INVENTION

The present invention relates, in general, to a networked digital displayed thinking systems and display writing tools and, more particularly, to displayed thinking systems capable of writing, reading, storing, recalling, updating, and tele-conferencing displayed thinking concepts using a digital network format.

### BACKGROUND OF THE INVENTION

Displayed thinking is a system for storyboarding ideas used by companies to quicken the pace of the development cycle and to better facilitate communication of ideas and project schedules. This system of dynamic brainstorming is usually facilitated by the users writing their ideas on index cards and pinning them to large 4×8 foot foam boards in columns under headings. The system is designed so that once the topic columns are set the users can add their ideas under each heading as the conversation flows. The cards are pinned to the board by thumbtacks, which makes them easily movable so that the ideas can be regrouped on the fly or organized however is desired. When the brainstorming is completed the ideas are “displayed” on the board so that others outside the team can view them and be easily briefed on the information presented on the board. This system of organizing thoughts is modeled after the concept of storyboarding that was invented by cartoon animators. It allows information to be displayed graphically so that it can be more easily interpreted. The process of displayed thinking is a powerful tool for capturing and communicating ideas but the system as it used and taught today has some significant drawbacks to it.

The information itself is hand written on cards which must be transcribed into a digital format by hand also if the information is going to be shared electronically. The system of using 4×8 foam boards to capture and display the cards is burdensome to handle by the team. After only a short while, a design team finds itself stacking these large boards all over their team area because they have too many of them. They are constantly shuffling them out of the pile so that a particular board can be added to or briefed from. In some cases the appearance of large numbers of boards scattered around a team area looks cluttered and takes up significant wall space, which in open creative environments is at a premium.

Displayed thinking is a hand written art that requires the users to be physically present in the room when the displayed thinking activity is going on. This also means that to teach displayed thinking to a group or to facilitate a session the teacher/facilitator must be physically present also.

Loban et al. disclose a video billboard including a remote computer control with radio communications to the billboard display in U.S. Pat. No. 5,612,741 ('741). The '741 patent discloses that display information is communicated from a master computer to a receiver in the billboard housing which, in turn, controls the light valve display of the '741 invention. Commands may also be communicated via shared or dedicated landlines. The '741 billboard is capable of providing complex video graphics with high contrast ratios. It can provide message changes on command through landline, cellular phone, satellite relay or other wireless communication links. Within the commercial advertising billboard industry it will allow the use of computer video control to change graphics easily and quickly, as desired. Advertisements, public service announcements or traffic conditions can be displayed in near real time from remote locations since images can be downloaded via the communication links and displayed at preprogrammed time slots, if desired.

Gofman et al. disclose a system and method for serving local and global media content in PCT publication WO 00/52935 ('52935). The '52935 publication discloses a system and method for combining broadcast media content with additional content at a local site according to at least one locally determined characteristic of the audience to which the combined content is served. The '52935 publication discloses a template containing information concerning the type of data objects to be displayed, their size and location on the display, as well as the timing of display and transitions to the display, such that the template describes how to process and display the data.

New materials are being developed that have the potential to expand display technology, such as, for example, GYRICON a trade name of Xerox Corporation, Palo Alto Research Center, Palo Alto, Calif. These new materials have the potential to expand the capabilities of billboard displays.

U.S. Pat. No. 6,058,417 ('417) titled Information Presentation and Management in an On-line Trading Environment, issued to Martin L. Hess et al. discloses the auctioning of items on the internet. The '417 patent describes person-to-person commerce over the Internet facilitated by providing prospective buyers the ability to quickly preview items for sale. Images are harvested from a plurality of sites based upon user-supplied information. The user-supplied information includes descriptions of items for sale and locations from which images that are to be associated with the items can be retrieved. Thumbnail images are created corresponding to the harvested images and are aggregated onto a web page for presentation at a remote site. According to another aspect of the '417 patent disclosure, a user may submit a query to preview items for sale. After receiving the query, thumbnail images corresponding to items that satisfy the user query are displayed, each of the thumbnail images previously having been created based upon a user-specified image.

It would be advantageous to provide an improved displayed thinking system that provides the advantages of digital formats and information exchange, without losing the interactive creativity and information exchange available with present systems. It would further be advantageous to record results from a displayed thinking session without redundant data entry. It would also be advantageous to provide a digital displayed thinking system capable of storing, recording, displaying, hiding, and combining multiple sessions. It would further be advantageous to display multiple boards of information from a single board, utilize less space, have the advantages of digital information, and have clearer to read and understand displayed thinking output. It would also be advantageous to enable remote collaboration, facilitation or training using displayed thinking. It would also be advantageous to provide an improved networked digital displayed-thinking device would include a digital display writing tool that would have the look and feel of a pen, and would allow the user to input information directly onto the display screen with hand writing while recording the information digitally and storing it in the system.

### SUMMARY OF THE INVENTION

A displayed thinking system according to the present invention may have all of the advantages of the current system but would address the current issues also. This system may include a display board that may have the same surface area as the 4×8 foot foam board but would be digital in format. This display board could be made from a digital paper technology so that it could digitally display information and could be flexible enough to roll up into a container such as a movie screen does today. This system may also include a networked server that may be attached to the digital display board and may control what information would be displayed on it. This server would be able to receive information from the users and convert them into digital cards that could be displayed on the screen. This server would already have the information in a digital format that could be communicated across the network as well as to the display board, possible even to remote display boards in other places. By capturing the information digitally in the server, a single display board could be used to brief any number of “pages” of displayed thinking data. This system would make it necessary to only have one display at minimum to display the information that is currently captured on a room full of boards.

The system may also include a set of user interfaces that may be networked into the server also. These user interfaces could be handheld computers or PDAs that may be held by the individual users and used to input information to the network server to be displayed. These handheld devices could be networked via a system like the airport wireless network built by Apple Computer Inc. In one embodiment these handheld devices may have handwriting recognition so that inputting information could be done with a stylus instead of a keyboard.

In another embodiment, one of the handheld devices could be the “master” device and could interact directly with the display to move cards around and edit the information being displayed while the rest of the handheld devices could be “slave” devices that only input information to the server.

In another embodiment the information could be displayed both on the board with the team and at a board located at a remote location so that another group that is not co-located with the main group could participate in the brainstorming or facilitate a training session. This remote group could also have master or slave handheld devices at its location that could interact via the existing network with the server and display boards.

In an embodiment of the present invention a stylus is provided, capable of writing directly onto the digital media. The digital media controller may be capable of reading the media to detect and record changes and additions to the display media produced from the stylus.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is an illustration of a digital displayed thinking system in accordance with the present invention;

FIG. 2 is an illustration of a stylus writing on the display surface of media in accordance with the present invention;

FIG. 3 is an illustration of a digital displayed thinking system in accordance with the present invention;

FIG. 4 is a block diagram of a controller for a displayed thinking system in accordance with the present invention;

FIG. 5 is a block diagram of an alternate embodiment of a controller for a displayed thinking system in accordance with the present invention; and

FIG. 6 is a block diagram of an alternate embodiment of a controller for a displayed thinking system in accordance with the present invention.

### DETAILED DESCRIPTION OF THE INVENTION

The present invention relates, in general, to a networked digital displayed thinking systems and display writing tools and, more particularly, to displayed thinking systems capable of writing, reading, storing, recalling, updating, and tele-conferencing displayed thinking concepts using a digital network format.

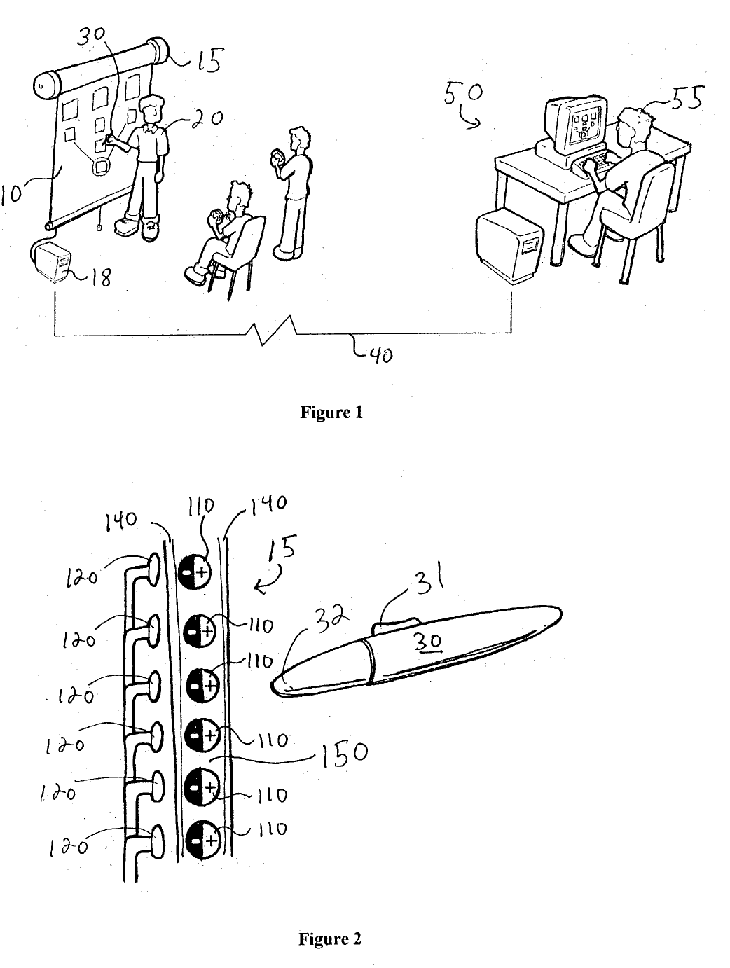

FIG. 1 shows a digital display writing tool 30 being used by a participant in the brainstorming session working with a networked digital display device 10. In this figure the networked digital display device 10 is connected to an external system 50 via a networked connection 40. As the participant 20 passes the digital display writing tool 30 over the surface of the digital display 15, writing appears on the digital display 15. This writing is digitized by the networked digital display device 10 and stored in the server 18. This information that is stored in server 18 can be transmitted to the external system 50 via networked connection 40 and displayed to the remote user 55.

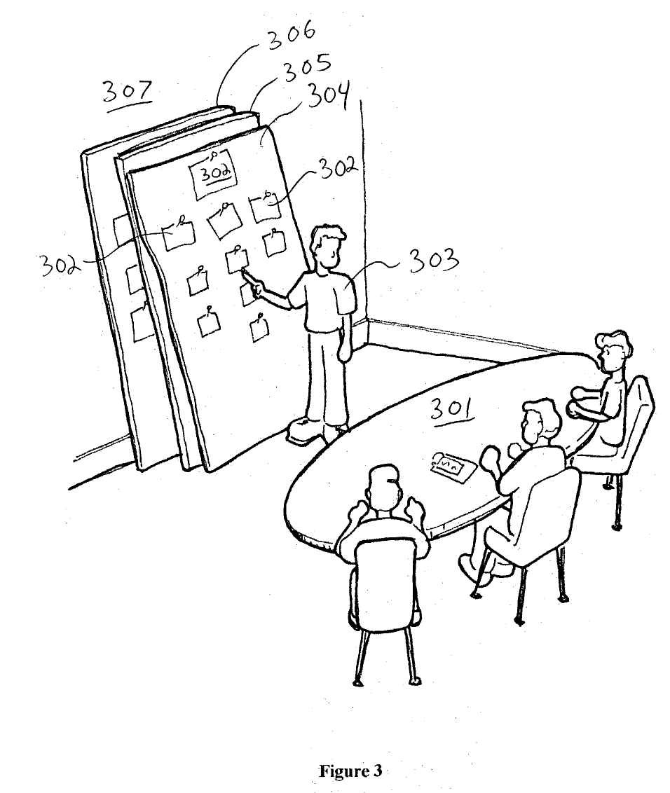

FIG. 2 shows a cross section of a digital display 15 with a digital writing tool 30 positioned close to it. The digital display 15 is composed of spheres 110 that are suspended in a oil 150 and secured between two plastic sheets 140. The digital display also has a series of one or more actuators 120 that are aligned with the spheres 110. In this embodiment, the spheres 110 are colored in two colors, each covering one half of the sphere and are aligned to the polarity of the sphere. In one embodiment these two colors could be black and white. The actuators 120 can flip the states of the spheres and spin them in the oil 150 so that they show either color to the outside of the display. The digital writing tool 30 is further composed of a switch 31 and an end-effector 32. As the switch 31 is toggled to one of two positions, the polarity of the end-effector 32 can be made positive or negative. This polarity would cause the spheres to move to match opposite polarities to that of the end-effector 32, thus changing their color state. Actuators 120 in either a passive mode or an active mode could detect this change in state of the spheres 110. By detecting this change of state the networked digital display device 10 could digitally store the change in its memo.

A suitable material for a displayed thinking media would be, for example, SMARTPAPER (Trademark of Gyricon Inc. Palo Alto, Calif.) technology using an array of tiny (100 micron diameter or smaller) solid beads with one sphere of each bead one color (e.g. white) and the other a different color (e.g. black). These beads are embedded in a flexible plastic sheet in small cavities surrounded by a liquid. Each bead carries an electrical charge. When an external electric field is applied the bead rotates or gyrates. Adhesive forces between each bead and cavity wall require an electrical threshold be exceeded before it will rotate. This makes an image electrically “printed” onto the material stable and unchanging until “erased” by another transmission. Electrical signals can be applied to the SMARTPAPER sheets through fixed surface electrodes or a moving stylus. A networked programmable sign will run for up to 2 years on 3 AA batteries, with the power almost completely used by the communications and processing systems. SMARTPAPER itself requires just a capacitance or voltage (about 100 volts), not a power current. Display battery power levels can be monitored by MaestroWare software and does not limit remote control addressability and functionality. Unlike other types of electronic displays, SMARTPAPER has a wide viewing angle identical to traditional printed signs. This allows SMARTPAPER to be viewed like paper, from all angles and without added backlighting. Images can currently be displayed on SMARTPAPER with resolution over 100 dpi. Applying electrical fields to the display surface changes the image on SMARTPAPER.

FIG. 3 shows a typical team area where displayed thinking is being conducted. The team members sit around a table 301 filling out cards 302 while a facilitator 303 pins them to a board 304 or potentially is briefing off of the board 304. FIG. 3 shows several boards 305, 306 stacked against wall 307 in a fashion described above.

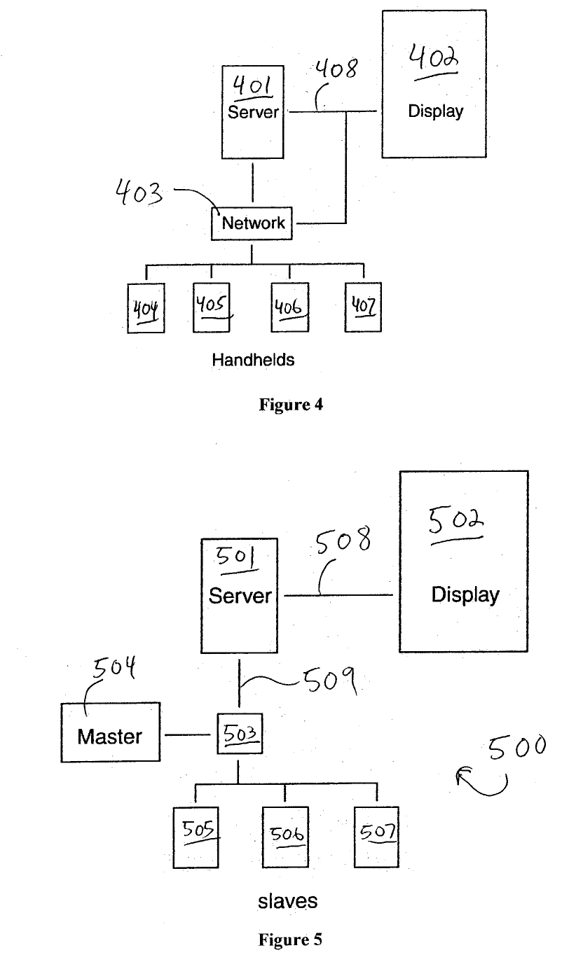

FIG. 4 illustrates an embodiment of the present invention including a server 401, a digital display 402, a network device 403 and a set of handheld PDAs 404 through 407. The PDAs 404 through 407 are connected to the server 401 through network device 403 in a duplex fashion. It is obvious that this connection could be done in a wired or wireless arrangement. The server 401 is likewise connected to the digital display 402 through a direct connection 408. It is known in the art that digital display 402 could alternatively be connected via a wireless connection either directly to the server 401 or through the network device 403. In another embodiment multiple digital display devices could be attached to a single server if more display information is desired.

FIG. 5 shows an embodiment of a digital displayed thinking system 500 that includes a server 501, a digital display 502, a network hub 503, a master handheld device 504 and a set of slave handheld devices 505 through 507. The handheld devices 504 through 507 are connected to the server 501 through network hub 503 in a duplex fashion. It is obvious that this connection could be done in a wired or wireless arrangement. The server 501 is likewise connected to the digital display 502 through a direct connection 508. It is known in the art that digital display 502 could alternatively be connected via a wireless connection either directly to the server 501 or through the network hub 503. In another embodiment multiple digital display devices 502 could be attached to a single server 501 if more display information is desired. The handheld devices 504 through 507 are also connected to the server 501 through a wired or wireless connection 509 through the network hub 503. In this embodiment the master handheld device 504 is used to control or edit the information that appears on the digital display 502. The slave handheld devices 505 through 507 are used solely to input information to the server 501 and can not be used to edit the information. It is obvious by using the digital displayed thinking system 500 that any combination of the server, digital display, master or slave handheld devices could be remotely located from each other.

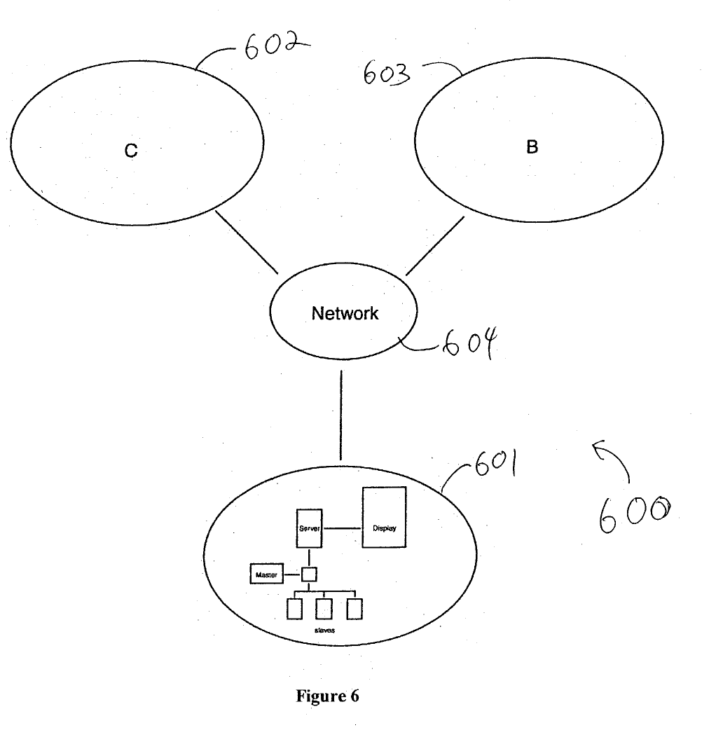

FIG. 6 shows a regional system 600 of networked digital display thinking systems 601, 602 and 603 are tied together through a network 604 such as, for example, the internet, LAN or other type of network. In this figure multiple systems, possible remotely located, are connected at a hierarchical level through a network system that would allow the users to share information between systems or to collaborate on the same project.

After a brainstorming session is completed, it may be desirable to record the final results. However, if a stylus such as digital display writing tool 30 is used to change existing information, the change may not be known to the controller. If a given display of SMARTPAPER is calibrated, such that it is known how much charge produces a positive or negative signal given an initial state of the display, the display may be queried. This query could then allow the controller to determine what was changed, and update the stored final copy of the information to include all the changes, as well as the previous information for reference.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features. In addition, it should be understood that every structure described above has a function and such structure can be referred to as a means for performing that function.

While preferred embodiments of the present invention have been shown and described herein, it will be obvious to those skilled in the art that such embodiments are provided by way of example only. Numerous variations, changes, and substitutions will be apparent to those skilled in the art without departing from the invention. Accordingly, it is intended that the invention be limited only by the spirit and scope of the appended claims.

What is claimed is:

1. A business method for displayed thinking comprising the steps of:
A) providing a digital displayed thinking system;
B) creating electronic cards for display
C) displaying the cards of step B on the system of step A; and
D) recording a set of displayed thinking cards into a digital file.

2. The method of claim 1 wherein in step A, the displayed thinking system comprises SMARTPAPER.

3. The method of claim 2 wherein PDA's are used to create electronic cards for display.

4. The method of claim 3 wherein displayed electronic cards are altered by a stylus.

5. The method of claim 4 wherein said displayed thinking system queries said display to detect altered information on said display.

6. A method for displayed thinking comprising the steps of:
A) providing a first digital displayed thinking system;
B) creating electronic cards for display;
C) displaying said electronic cards of step B on said first digital displayed thinking system of step A;
D) recording a set of displayed thinking cards into a digital file;
E) providing a second digital displayed thinking system;
F) transmitting said digital file from said first digital displayed thinking system to said second digital displayed thinking system; and
G) displaying said electronic cards of step B on said second digital displayed thinking system of step E.

7. The method of claim 6 wherein in step A, the displayed thinking system comprises SMARTPAPER.

8. The method of claim 6 wherein PDA's are used to create electronic cards for display.

9. The method of claim 6 wherein displayed electronic cards are altered by a stylus.

10. The method of claim 6 wherein said displayed thinking system queries said display to detect altered information on said display.

11. The method of claim 8 wherein displayed electronic cards are altered by a stylus.

12. The method of claim 8 wherein said displayed thinking system queries said display to detect altered information on said display.

13. The method of claim 12 further including the step of:
H) recording said altered information into a digital changes file.

14. The method of claim 13 further including the step of:
J) transmitting said digital changes file from said first digital displayed thinking system to said second digital displayed thinking system.

15. A digital displayed thinking system comprising:
a plurality of digital displays;
a plurality of handheld devices; and
a communication network, wherein said handheld devices are adapted to transmit information to said digital displays, and said digital displays are adapted to transmit said information to other digital displays via said communication network.

16. The digital displayed thinking system of claim 15, wherein the digital displayed thinking system comprises SMARTPAPER.

17. The digital displayed thinking system of claim 16, wherein the digital displayed thinking system further comprises a digital display writing tool.

18. The digital displayed thinking system of claim 17, wherein said digital displayed thinking system is adapted to query said digital displays to determine changes on said digital displays from use of said digital display writing tool.

19. The digital displayed thinking system of claim 18, further comprising memory, said memory adapted to store said information.

20. The digital displayed thinking system of claim 19, wherein said memory is adapted to continuously store changes to said information during a brainstorming session using said digital displayed thinking system.
